(19) United States
(12) Patent Application Publication
(10) Pub. No.: US 2010/0129717 A1
(43) Pub. Date: May 27, 2010

(54) Microbattery on a substrate with monolithic packaging

(75) Inventors: Messaoud Bedjaoui, Echirolles (FR); Steve Martin, Saint-Sauveur (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, PARIS (FR)

(21) Appl. No.: 12/591,443

(22) Filed: Nov. 19, 2009

(30) Foreign Application Priority Data
Nov. 21, 2008 (FR) 08 06540

(51) Int. Cl. H01M 4/58; H01M 4/04

(52) U.S. Cl. 429/231.95; 29/623.5

(57) ABSTRACT

The microbattery comprises a first current collector and a second current collector arranged on a substrate, and a stack comprising two electrodes separated by an electrolytic film. Each electrode is connected to a corresponding collector, one of the electrodes being a lithium-based anode. The stack is covered by a packaging comprising a metal layer. The first current collector is salient from the packaging and the second current collector is in contact with the metal layer. An alumina plug with a thickness of less than 30 nm is arranged between the first current collector and the metal layer, the electrode in contact with the first current collector being electrically insulated from the metal layer by the alumina plug.

### BACKGROUND OF THE INVENTION

The invention relates to a microbattery comprising a first current collector and a second current collector arranged on a substrate, and a stack comprising two electrodes separated by an electrolytic film, each electrode being connected to a corresponding collector, one of the electrodes being a lithium-based anode, said stack being covered by a packaging comprising a metal layer, the first current collector being salient from the packaging and the second collector being in contact with the metal layer.

### STATE OF THE ART

Lithium microbatteries essentially comprise reactive elements, in particular the anode which is very often formed by lithiated components. Metal lithium reacts rapidly to exposure to atmospheric elements such as oxygen, nitrogen or water vapor, resulting in accelerated aging of the battery. Protections have been developed to overcome these deterioration problems. Microbatteries are thus conventionally provided with a protection envelope that is sufficiently tight with respect to the atmosphere and perfectly compatible with the layers used in the microbattery to prevent any leakage.

Two protection concepts exist, the envelope and monolithic packaging.

A microbattery is said to be enveloped when a cover tightly sealed with respect to the atmosphere is placed overlying the microbattery to protect the latter. Conventionally, securing of the cover is performed in a controlled atmosphere in the presence of an inert gas such as argon. This technology comprises several drawbacks, the main ones being the long-term reliability of the microbattery and the difficulty of monitoring the tightness of the cover to prevent any contamination from the outside. Furthermore, enveloped microbatteries generally have too large dimensions which do not meet the requirements of specifications.

In a monolithic packaging, the barrier separating the components at risk from the external environment is achieved by deposition of thin layers.

U.S. Pat. No. 5,561,004 describes a microbattery with monolithic packaging. As illustrated in FIG. 1, the microbattery is made on a base substrate 1 on which a first current collector 2 and a second current collector 3 are arranged, current collectors 2 and 3 being separated by a portion 6 of substrate. A layer forming a cathode 4 is deposited on first current collector 2 (on the left in FIG. 1) leaving a free outer area 12 of first collector 2 to the left of cathode 4 for the electrical connections to be made. An electrolytic film 5 is then deposited so as to cover cathode 4, a section of portion 6 of substrate separating the two collectors 2 and 3 as well as a part of the free area of first collector 2. A lithium anode 7 is arranged overlying electrolytic film 5 and covers a part of second current collector 3. The cathode/electrolytic film/anode stack is then covered by an encapsulation layer 13 comprising a polymer layer and a metal layer. The patent suggests that the metallic layer be electrically insulated: without insulation, the two collectors 2, 3 of FIG. 1 are in fact short-circuited. However this patent does not specify where the insulation is to be made, nor does it specify the type of material to be used. Current requirements require lithium microbatteries to last for at least 10 years, which corresponds for certain types of batteries to an oxygen and humidity barrier value of 10⁻⁴ g/m²/J. The choice of material therefore has to take these requirements into account and has to be consistent with the adjacent layers in order not to damage the latter.

### OBJECT OF THE INVENTION

The object of the invention is to provide a microbattery having a sufficient oxygen and humidity barrier value and a consistency of materials forming the different layers that prevents any degradation of the microbattery.

This object is achieved by the appended claims, and in particular by means of an alumina plug with a thickness of less than 30 nm, arranged between the first current collector and the metal layer, the electrode in contact with the first current collector being electrically insulated from the metal layer by the alumina plug.

The invention also relates to a fabrication method successively comprising:
formation of the first current collector and second current collector on the substrate,
formation of the plug on the first collector and production of the stack,
encapsulation of the stack by a metal layer in electrical contact with the second current collector on the one hand and in contact with the alumina plug on the other hand.

### BRIEF DESCRIPTION OF THE DRAWINGS

Other advantages and features of the invention will become more clearly apparent from the following description of particular embodiments of the invention given for non-restrictive example purposes only and represented in the accompanying drawings in which:

FIG. 1 illustrates a microbattery according to the prior art.

FIG. 2 illustrates a microbattery according to an embodiment of the invention.

FIGS. 3 to 5 illustrate a method of production of a microbattery according to FIG. 2.

FIG. 6 illustrates a second embodiment of a microbattery according to the invention.

### DESCRIPTION OF PARTICULAR EMBODIMENTS

As illustrated in FIG. 2, a microbattery comprises a first current collector 2 and a second current collector 3 arranged on a substrate 1. A conventional stack comprising two electrodes 4, 7 separated by an electrolytic film 5, is arranged between the two current collector 2 and 3. Each electrode 4, 7 is in electrical contact with a corresponding current collector 2, 3. One of the electrodes is a lithium anode or a lithium-base anode. The stack is covered by a packaging comprising a metal layer 8 providing optimum protection of said stack against attacks from the outside environment. To prevent any short-circuiting between the two current collectors 2 and 3, metal layer 8 of first current collector 2 has to be insulated while at the same time preserving a good compromise on the permeability of the microbattery. Insulation meeting requirements is achieved by an alumina plug 9 arranged between first current collector 2 and metal layer 8 enabling efficient packaging of the microbattery. A part of first current collector 2 is salient from the packaging making said first current collector 2 accessible to perform the connections of the microbattery. Second current collector 3 is for its part in contact with metal layer 8 of the packaging. Naturally, to prevent short-circuiting between the electrode in contact with first current collector 2 and metal layer 8, these two elements are electrically insulated from one another, this insulation can be performed by the alumina plug 9.

Present-day technologies do not enable thick layers of non-porous alumina to be obtained, i.e. the leak-tightness to water vapor, oxygen and nitrogen of an alumina plug 9 produced as a thick layer cannot satisfy the required penetration conditions, for example less than 10⁻⁴ g/m²/J. Moreover, locating alumina plug 9 in the bottom part of the microbattery and placing it in contact with electrolytic film 5 and/or lithium anode 7 poses a problem as to the efficiency of the microbattery. When the microbattery is operating, the ions will in fact move from anode 7 to cathode 4, and the risk of the lithium diffusing into the bottom layers of the battery is not negligible. If the lithium diffuses into the material acting as plug 9, this would have a twofold consequence: reduced efficiency of the battery and damage to plug 9, able to make said plug 9 porous to attacks from the outside environment, or even electrically conducting. Although this risk can be partially compensated by increasing the thickness of the alumina layer, this would be to the detriment of the tightness. The alumina plug 9 has to achieve a good compromise between tightness and lithium diffusion. This compromise is achieved if the alumina plug has a thickness of less than 30 nm, and preferably comprised between 20 nm and 30 nm. Such a plug is in fact chemically stable and physically very dense, i.e. it presents a very low porosity. Tests were carried out on a stack formed by a lithium layer and an alumina layer of 25 nm, the alumina layer being deposited for example by atomic layer deposition (ALD). No diffusion or interaction between these two layers was observed. Furthermore, during the tests, the stack underwent annealing at 300° C. without any interaction being observable. These tests therefore showed the inertia, the chemical and thermal stability of an alumina layer of nanometric thickness in contact with a lithium layer.

In a general manner, deposition of the layer forming alumina plug 9 using, preferably, atomic layer deposition ALD gives plug 9 an atomic density and arrangement such that a very thin layer becomes impermeable to oxygen while at the same time having electrical insulation properties. As a counter-example, an 80 nm layer of alumina has a coefficient comprised between 10⁻³ g/m²/J and 10⁻² g/m²/J, such a coefficient not being sufficient to ensure a good impermeability.

The layer forming alumina plug 9 preferably has a thickness comprised between 20 and 30 nm.

Alumina in a nanometric layer becomes a very good material as far as the oxidizing gas penetration characteristic is concerned. It can in fact have a coefficient of penetration of 10⁻⁵ g/m²/J less than the preferably required maximum of 10⁻⁴ g/m²/J enabling prolonged operation of the microbattery. Providing an alumina packaging layer could have been sufficient, however this material is relatively breakable and dilatation of the microbattery in operation would have led to mechanical stresses liable to damage the packaging. Once the packaging layer had cracked, it would have lost all the properties of providing a barrier against the environment. This is why it was chosen to use an alumina plug in a nanometric layer, the properties of resistance to lithium diffusion of which were hitherto unknown, to complete a metal packaging while leaving the collectors accessible on one surface of the substrate.

Other materials such as silica or silicon nitride were tested to produce plug 9. Silica was discarded as the coefficient of penetration of this material is about 10⁻² g/m²/J which is insufficient. Silicon nitride was also discarded as its coefficient of penetration is 10⁻³ g/m²/J.

First current collector 2, on which alumina plug 9 is arranged, is salient from the packaging, area 12 left free by the salience enabling a first connection terminal 10a to be installed, a second terminal 10b being able to be disposed on metal layer 8. This salience avoids having to drill the substrate via its surface opposite the microbattery to make the electrical connections on first current collector 2. This is possible due to the low permeability of the nanometric layer of alumina forming plug 9 enabling first current collector 2 to be salient from the packaging without degrading the battery prematurely, while at the same time insulating electrically first current collector 2 from second current collector 3.

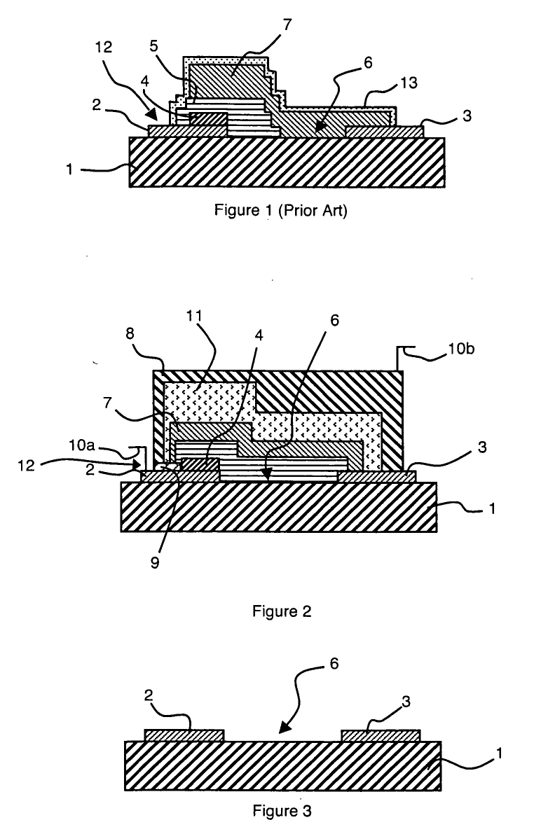

According to the particular embodiment illustrated in FIG. 2, the micro-battery is produced on a base substrate 1 on which first and second current collectors 2, 3 are arranged separated by a portion 6 of substrate. A cathode 4 is arranged on first current collector 2 (on the left of FIG. 1) and alumina plug 9 is adjoined to cathode 4 to the left of said cathode 4 leaving a free area 12 of the collector to the left of the alumina plug 9. Electrolytic film 5 covers the whole (FIG. 2) of the plug 9 and at least a section of portion 6 of the substrate separating the two current collectors 2 and 3. In this case, it can also cover a part of alumina plug 9. Electrolytic film 5 can also cover the whole of portion 6 of substrate 1 separating the two current collectors 2 and 3, and an area of second collector 3, enabling the volume of the electrolyte to be increased without increasing its thickness. Lithium-based anode 7 is arranged overlying electrolytic film 5 and is in electrical contact with second current collector 3. Anode 7 can also completely cover electrolytic film 5 and therefore be in contact with alumina plug 9. The cathode/electrolytic film/anode stack is covered by a packaging comprising a covering layer 11, preferably made of polymer, followed by a metal layer 8. Although metal layer 8 could have been deposited directly overlying anode 7, deposition thereof would have damaged the lithium constituting anode 7 thereby resulting in a loss of efficiency of the battery. This is why a covering layer 11 completely covering the anode is deposited before the stack is covered by metal layer 8 up to the two current collectors 2 and 3. Polymer layer can further present a lower surface roughness than that of the anode. The performances of the metal barrier are thereby enhanced. Second collector 3 is in electrical contact with metal layer 8 of the packaging and first collector 2 is electrically insulated from the metal layer by alumina plug 9. If the covering layer 11 is in contact with the first current collector 2 and the second current collector 3, said covering layer 11 is electrically insulated.

According to a second embodiment illustrated in FIG. 6, cathode 4 is arranged on second current collector 3. Electrolytic film 5 covers cathode 4, portion 6 of substrate and a part of first current collector 2. Lithium anode 7 is arranged overlying electrolytic film and is in electrical contact with first current collector 2. A polymer covering layer 11 covers the stack. Encapsulation is completed by the alumina plug arranged on first current collector 2 and by a metal layer 8, insulated from first current collector 2 by alumina plug 9, and in contact with second current collector 3. The first collector 2 is salient from the packaging to enable a first connection terminal 10a to be made. A second connection terminal 10b is connected to metal layer 8.

To prevent the stack from short-circuiting with metal layer 8, the electrode in contact with first current collector 2 has to be electrically insulated from metal layer 8. This insulation can be achieved by the alumina plug 9 and by the covering layer 11, for example made of polymer, fitted between metal layer 8 and the stack. As described above, the alumina plug 9 also takes part in the electric insulation.

The method for producing the microbattery comprises at least the following steps:
formation of first current collector 2 and second current collector 3 on substrate 1,
formation of an alumina plug 9 with a thickness of less than 30 nm, preferably comprised between 20 nm and 30 nm, on first current collector 2 and production of the stack comprising electrolytic film 5 sandwiched between anode 7 and cathode 4,
encapsulation of the stack by a metal layer 8 in electrical contact with the second current collector 3 on the one hand and in contact with the alumina plug 9 on the other hand.

According to a particular embodiment illustrated in FIGS. 2 to 5, the method for producing the microbattery comprises a first step consisting in forming first and second current collectors 2, 3 on one and the same surface of a support substrate 1 (FIG. 3), these two current collectors 2, 3 being separated by a portion 6 of substrate. The substrates used are generally made of glass, silicon or silicon nitride. Silicon nitride presents the advantage of a greater resistance to lithium diffusion and will therefore be preferred. This step of forming first and second current collectors 2, 3 can be performed using any type of thin layer deposition technique such as Physical Vapor Deposition (PVD) or Chemical Vapor Deposition (CVD). The first and second current collectors 2, 3 are preferably made from titanium, tungsten or gold and have a thickness of about 200 nm.

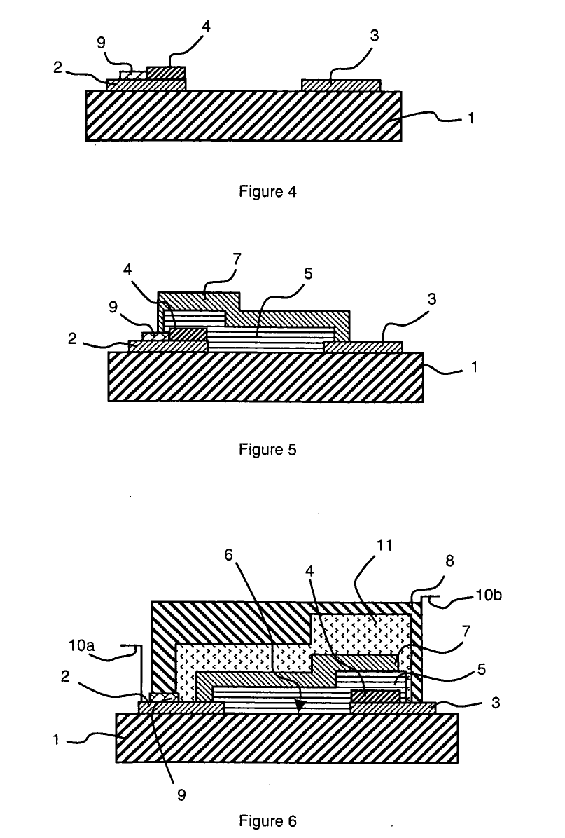

An alumina layer is then deposited to form plug 9 on first collector 2, leaving a free area of first current collector 2 on each side of plug 9. This alumina plug 9 has a thickness of less than 30 nm, preferably comprised between 20 nm and 30 nm, and is achieved by atomic layer deposition (ALD) at ambient temperature. What is meant by ambient temperature is a temperature comprised between 20° C. and 60° C. Cathode 4 is then formed to the right of plug 9 (in FIG. 4). This cathode 4 is in contact with alumina plug 9 and has a larger thickness than the thickness of the alumina plug 9. The cathode preferably extends from plug 9 up to the end of first current collector 2 which is directed towards second current collector 3. Cathode 4 is preferably deposited by conventional methods such as vacuum evaporation deposition or cathode sputtering. In most cases, cathode 4 can be made from titanium oxysulfide TiOS, vanadium pentoxide V₂O₅ or titanium disulfide TiS₂. One of the advantages of the ALD method is the low temperature involved. The other materials already deposited are therefore not liable to be damaged, unlike with conventional silica or silicon nitride deposition methods which require deposition temperatures of about 400° C.

Cathode 4 can therefore be deposited either before or after the plug has been formed. However it may be advantageous to produce the substrate/collectors/plug assembly in a first step in a conventional deposition frame and then transfer this assembly to another frame dedicated to deposition of the specific layers of the microbattery stack.

The next step consists in depositing electrolytic film 5, preferably made from LiPON. This film is generally produced by cathode sputtering (PVD) or by chemical vapor deposition (CVD). Cathode sputtering is to be preferred as it enables a defect-free continuous layer of very small thickness to be obtained, the thickness being about 1.5 μm. Electrolytic film 5 is preferably formed in such a way as to cover both cathode 4 and a part of plug 9 and at least a part of portion 6 of substrate 1 separating the two collectors (FIG. 5). Electrolytic film 5 preferably covers the whole of the portion separating the two collectors 2, 3 and a part of second collector 3.

After the electrolytic film 5 has been deposited, lithium anode 7 is formed, for example by sputtering. The average thickness of this anode 7 is preferably 3 μm and it is deposited such as to be in electrical contact with second current collector 3 and electrolytic film 5. According to an alternative embodiment, anode 7 covers the whole of the electrolytic film and is in contact with a part of alumina plug 9 (FIG. 2).

In the last step, the microbattery is encapsulated to protect it from the humidity of the air. The encapsulation step comprises deposition of a covering layer totally covering the cathode/electrolytic film/anode stack. This covering layer 11 is preferably an unstressed planarizing layer of a polymer such as parylene. A planarizing layer is a layer that enables the topography of the surface to be reduced after deposition, i.e. to have a flatter surface after deposition than before deposition. This covering layer 11 further enables the mechanical stresses of the microbattery to be absorbed in operation. This covering layer preferably has a thickness comprised between 2 and 5 μm, for example 3 μm, and it can be obtained by vacuum evaporation deposition. The polymer layer in itself not being sufficient to achieve tightness of the microbattery, the latter is covered by metal layer 8 electrically connected to second collector 3 and in contact with alumina plug 9 which ensures that no short-circuiting is possible between the two current collectors 2, 3. Metal encapsulation layer 8 is preferably chosen from the group formed by titanium, platinum, aluminum, copper or an alloy of these materials.

The method described above can naturally be adapted to produce the micro-battery represented in FIG. 6.

1. A microbattery comprising a first current collector and a second current collector arranged on a substrate, a stack comprising two electrodes separated by an electrolytic film, each electrode being connected to a corresponding collector, one of the electrodes being a lithium-based anode, said stack being covered by a packaging comprising a metal layer, the first current collector being salient from the packaging and the second current collector being in contact with the metal layer, a microbattery wherein an alumina plug with a thickness of less than 30 nm is arranged between the first current collector and the metal layer, the electrode in contact with the first current collector being electrically insulated from the metal layer by the alumina plug.

2. The microbattery according to claim 1, wherein the alumina plug has a thickness comprised between 20 and 30 nm.

3. The microbattery according to claim 1, wherein the alumina plug has a coefficient of penetration of less than 10⁻⁴ g/m²/J.

4. The microbattery according to claim 1, wherein the packaging comprises a covering layer of polymer intercalated between the metal layer and the stack.

5. A method for producing a microbattery according to claim 1, successively comprising:
formation of the first current collector and second current collector on the substrate,
formation of the alumina plug on the first collector and production of the stack,
encapsulation of the stack by a metal layer in electrical contact with the second current collector on the one hand and in contact with the alumina plug on the other hand.

6. The method according to claim 5, wherein one of the electrodes is a cathode in contact with the first current collector, said cathode being made from a material chosen from TiOS, TiS2 or V2O5.

7. The method according to claim 5, wherein the alumina plug is deposited by ALD at a temperature comprised between 20° C. and 60° C.
